(19) United States
(12) Patent Application Publication
(10) Pub. No.: US 2009/0292382 A1
(43) Pub. Date: Nov. 26, 2009

(54) METHOD FOR SETTING ACTION STEPS OF MOLD CORE

(75) Inventor: Hsing-Chang Liu, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXNUM TECHNOLOGY CO., LTD., Tucheng City (TW)

(21) Appl. No.: 12/261,019

(22) Filed: Oct. 29, 2008

(30) Foreign Application Priority Data
May 26, 2008 (CN) 200810301783.1

(51) Int. Cl. G06F 19/00

(52) U.S. Cl. 700/103

(57) ABSTRACT

A method for setting action steps of a mold core, used in a mold core control system, the method comprising setting the desired number of mold cores. The control system implements action mode settings for each mold core, based on individual requirements. The control system implements action timing settings for each mold core, based on individual requirements. The control system implements working parameter settings for each mold core, based on individual requirements.

### BACKGROUND

1. Field of the Invention

The invention generally relates to injection molding and, particularly, to a method for setting action steps of a mold core.

2. Description of the Related Art of the Invention

Referring to FIG. 1, a mold core control system includes a human-machine interface. The mold core functions correspond to the design of the mold and therefore can be very complicated, resulting in the operating interface of the mold core control system compromising user-friendliness. The interface cannot show the action steps of the mold core clearly, subjecting the process of setting action steps susceptible to user error and damage to the mold.

What is needed, therefore, is a method for setting action steps of a mold core addressing the described limitations.

### BRIEF DESCRIPTION OF THE DRAWINGS

FIG. 1 is a diagram of a conventional dialog box of a human-machine interface for setting a mold core.

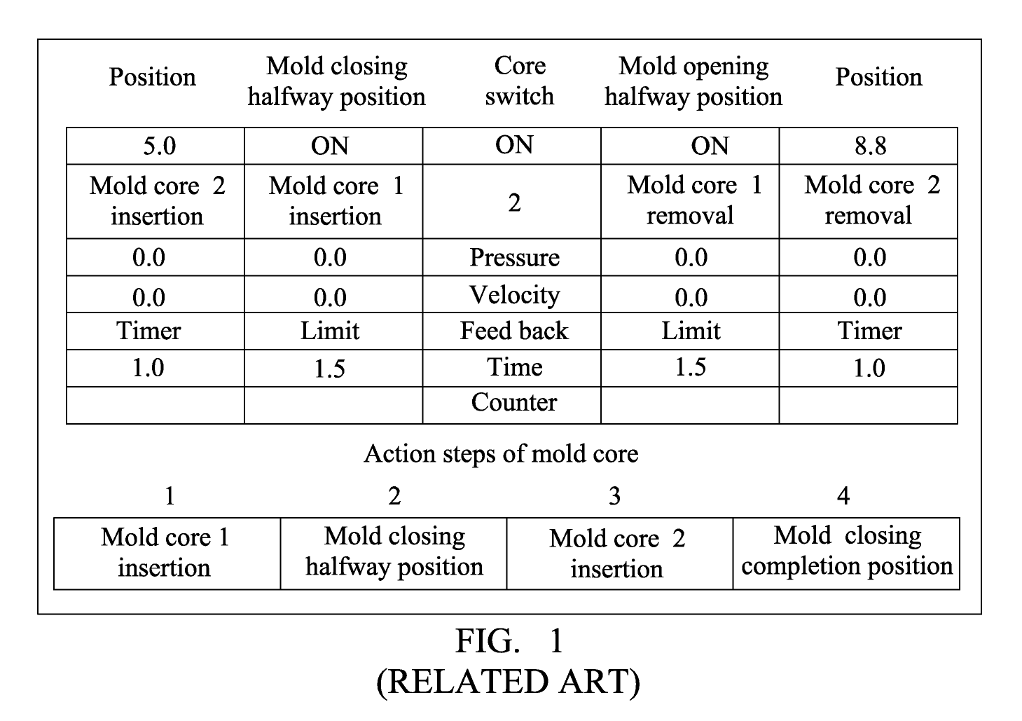

FIG. 2 is a diagram of a dialog box of a human-machine interface in accordance with an embodiment of the disclosure, showing a method for setting action steps of a mold core.

FIG. 3 is a block diagram of a method for setting action steps of a mold core in accordance with an embodiment of the disclosure.

FIG. 4 is a diagram of the dialog box of the human-machine interface in accordance with an embodiment of the disclosure, showing the method for setting action steps of a mold core.

FIG. 5 is a diagram of the dialog box of the human-machine interface in accordance with an embodiment of the disclosure, showing the method for setting action steps of a mold core.

FIG. 6 is a diagram of the dialog box of the human-machine interface in accordance with an embodiment of the disclosure, showing the method for setting action steps of a mold core.

### DETAILED DESCRIPTION OF THE EMBODIMENTS

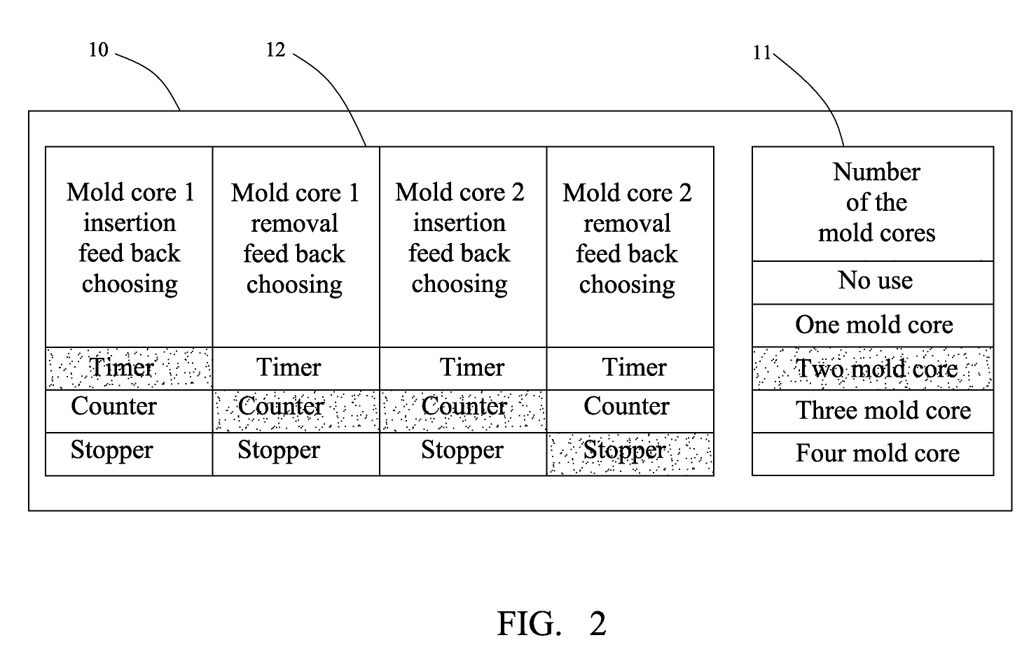

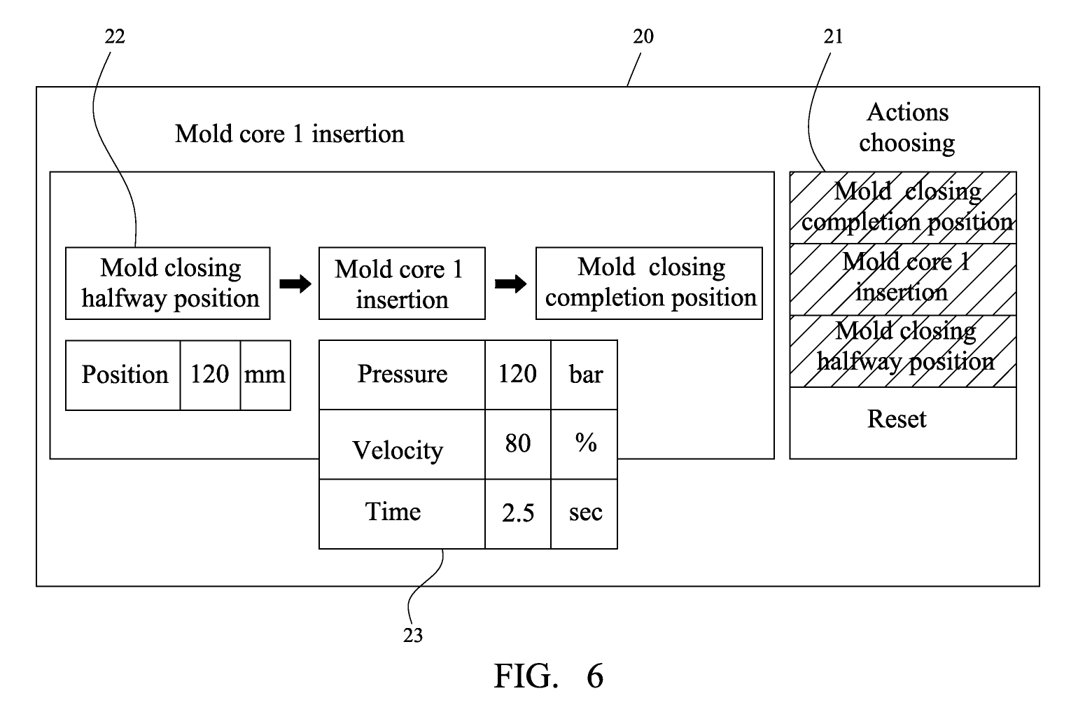

Referring to FIG. 2, a method for setting action steps of a mold core in accordance with an exemplary embodiment is provided. The method can be performed to set action steps of a mold core for an injection molding machine including a control system having a display device. Also referring to FIG. 6, the control system includes an interface module generating a first dialog box 10 and a second dialog box 20, on the display device. The first dialog box 10 includes a first input menu 11 providing selection of numbers of mold cores to be used and a second input menu 12 for setting action modes of each mold core. The second dialog box 20 includes a setting menu 21 providing selection of action timings of each mold core, a display menu 22, which can be viewed through the display device, and a setting menu 23 for setting working parameters of each mold core. A user can input data or choose an option in first dialog box 10 and second dialog box 20.

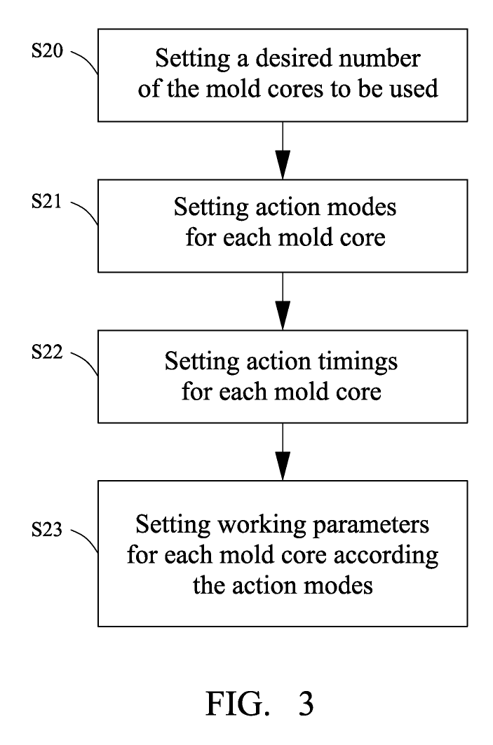

Referring to FIG. 3, the method includes the following.

In Step S20, the number of the mold cores to be used is set according to different manufacturing requirements. In Step S21 the action mode is set for each mold core. In this embodiment, TWO is chosen from first input menu 11 of the first dialog box 10, with the second input menu 12 of the first dialog box 10 showing two setting fields accordingly.

In Step S21, the control system implements action mode setting of each mold core, based on individual requirements. In step 22, action timing is set for each mold core. If more than one mold cores are used, action modes are set individually. Here in FIG. 2, “TIMER” is selected as action mode for insertion of mold core 1 feedback; “COUNTER” is selected as action mode of mold core 1 removal feedback and mold core 2 insertion feedback; “STOPPER” is selected as action mode of mold core 2 removal feedback.

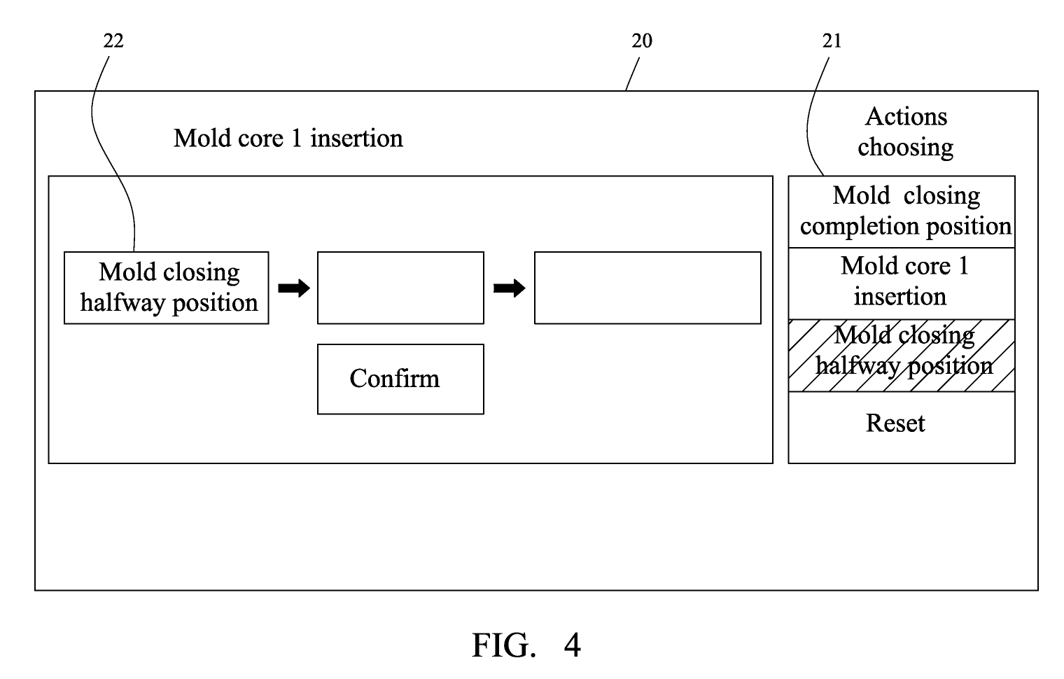

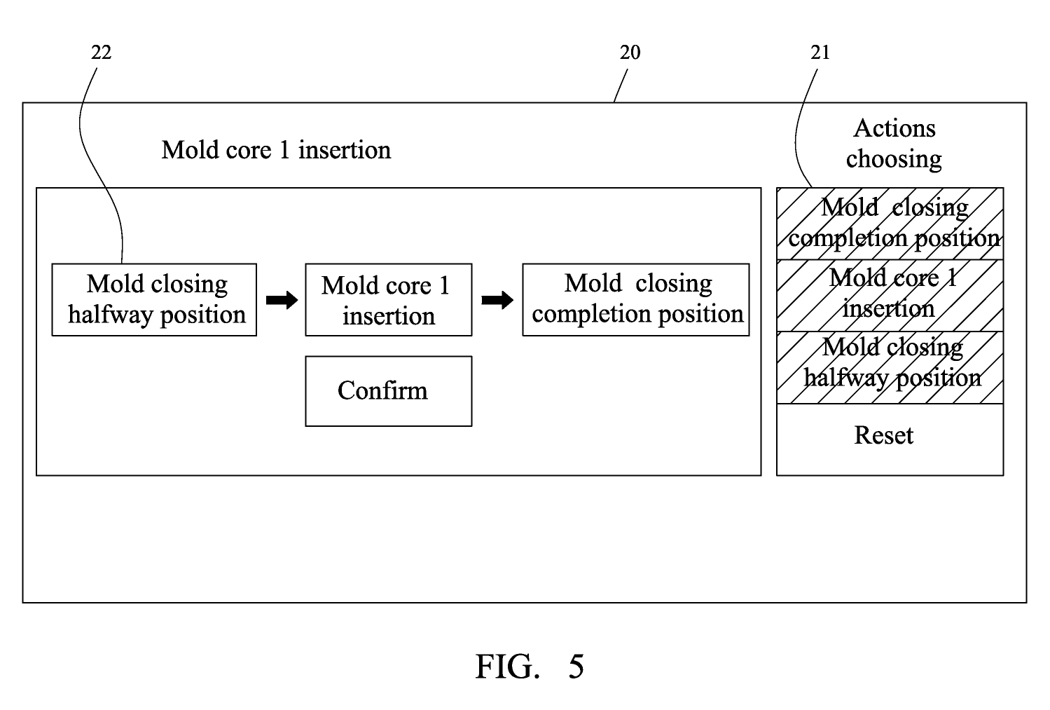

In Step S22, the control system implements action timing setting of each mold core, based on individual requirements. In step 23, working parameters are set for each mold core. In this example, action timings of mold core 1 insertion are to be set. Referring to FIG. 4, if “MOLD CLOSING HALFWAY POSITION” is selected as a first step of the core action timing setting of each mold core setting menu 21 of the second dialog box 20, the display menu 22 of the dialog box 20 shows “MOLD CLOSING HALFWAY POSITION” for each mold accordingly. Referring to FIG. 5, if “MOLD CLOSING COMPLETION POSITION” is selected as a final step of the core action timing setting of each mold core setting menu 21 of the second dialog box 20, the display menu 22 of the dialog box 20 shows “MOLD CLOSING COMPLETION POSITION” for each mold accordingly.

In Step S23, the control system implements working parameters for each mold core, based on individual requirements. Referring to FIG. 6, in this example, a position of “MOLD CLOSING HALFWAY POSITION” is to be set as 120 mm in the setting menu 23 of the second dialog box 20. Pressure of “MOLD CORE 1 INSERTION” is set at 120 bar. Velocity of “MOLD CORE 1 INSERTION” is set at 80%. Atime of “MOLD CORE 1 INSERTION” is set at 2.5 sec. The setting menu 23 of the second dialog box 20 corresponds to the selection in the first input menu 11 of the first dialog box 10.

Finally, it is to be understood that the above-described embodiments are intended to illustrate rather than limit the invention. Variations may be made to the embodiment without departing from the spirit of the invention as claimed. The above-described embodiments illustrate the scope of the invention but do not restrict the scope of the invention.

What is claimed is:

1. A method for setting action steps of a mold core, used in a mold core control system, the method comprising:
setting a desired number of mold cores to be used;
setting action modes for each mold core;
setting action timings for each mold core; and
setting working parameters for each mold core according the action modes.

2. The method as claimed in claim 1, wherein the control system includes an interface module providing a first dialog box and second dialog box, the first dialog box including a first input menu providing selection of numbers of mold cores to be used and a second input menu for setting action modes of each mold core, and the second dialog box including a setting menu providing selection of action timings for each mold core, a display menu on the display device, and a setting menu for setting working parameters of each mold core.

3. The method as claimed in claim 2, wherein the setting menu of the second dialog box corresponds to selection at the first input menu of the first dialog box.

4. The method as claimed in claim 1, wherein, if more than one mold cores is to be set, the action modes are set individually.

5. The method as claimed in claim 1, wherein, if more than one mold core is to be set, the action timings are set individually.

6. The method as claimed in claim 1, wherein, if more than one mold core is to be set, the working parameters are set individually.
